(19) United States
(12) Patent Application Publication
(10) Pub. No.: US 2025/0078222 A1
(43) Pub. Date: Mar. 6, 2025

(54) DATA PROCESSING APPARATUS, METHOD THEREFOR, IMAGE PROCESSING APPARATUS, AND STORAGE MEDIUM

(71) Applicant: CANON KABUSHIKI KAISHA, Tokyo (JP)

(72) Inventor: TAKAMASA TSUNODA, Tokyo (JP)

(21) Appl. No.: 18/815,476

(22) Filed: Aug. 26, 2024

(30) Foreign Application Priority Data
Aug. 30, 2023 (JP) 2023-140407

(51) Int. Cl. G06T 5/77; G06T 7/20; G06V 10/44

(52) U.S. Cl. CPC G06T 5/77; G06T 7/20; G06V 10/44

(57) ABSTRACT

A data processing apparatus includes at least one processor, and at least one memory storing instructions that, upon execution of the stored instructions, cause the at least one processor to calculate a restoration error associated with restoration of a restored image sequence based on the restored image sequence restored from a degraded image sequence obtained by degrading a reference image sequence and at least one of the reference image sequence or the degraded image sequence, calculate a score according to a type of a feature amount based on the restoration error and a feature amount of a predetermined type extracted from the degraded image sequence, and extract a reference image sequence to be used for creating a data set from a series of the reference image sequences based on the score.

### BACKGROUND

### Field

The present disclosure relates to a data processing apparatus, a method therefor, image processing apparatus, and a storage medium.

### Description of the Related Art

Examples of image processing to be performed on a target image include image quality improvement processing such as noise reduction processing for reducing noise occurring in an input image, super-resolution processing for enhancing the resolution of an input image, and blur removal processing for removing a blur generated due to a motion of a subject or a focus. A technique for implementing such image processing using a learning model (hereinafter also referred to simply as a model) constructed based on machine learning has recently been discussed.

Many of image quality improvement processing techniques using a model generate a degraded image by modeling an image quality degradation process and simulating a degradation that can occur on an image before degradation. The degraded image thus generated is used as input data and model learning is performed by supervised learning using the image before degradation as a ground truth (GT). The model obtained as a result of this processing is applied to image quality improvement processing.

In general, a user adds, as an annotation, a GT corresponding to a recognition result of an input image to the image to create the GT to be used for supervised learning in an image recognition task such as image classification or object detection from an image. This results in a considerable increase in cost. On the other hand, the use of a degradation process model to create the GT in an image quality improving task eliminates the need for using an annotation, which makes it possible to relatively easily increase the amount of data. However, if training data is randomly selected from available sources of still images and moving images, it may be difficult to extract samples with a higher learning effect. In this regard, a technique called Hard Example Mining (HEM) is discussed as a technique for obtaining training data with a higher learning effect. Abhinav Shrivastava, Abhinav Gupta, Ross Girshick, Training Region-based Object Detectors with Online Hard Example Mining, CVPR 2016 (2016) discuss an HEM technique in object detection. Wang, Shizun, et al. “SamplingAug: On the Importance of Patch Sampling Augmentation for Single Image Super-Resolution.” arXiv preprint arXiv: 2111.15185 (2021) discuss an HEM technique in super-resolution imaging.

The technique discussed by Abhinav Shrivastava, Abhinav Gupta, Ross Girshick, Training Region-based Object Detectors with Online Hard Example Mining, CVPR 2016 (2016) is based on a specific structure in which a feature map on an entire input image is estimated and a final inference process is performed in a part of the feature map. Accordingly, a network structure for a target neural network is limited.

The technique discussed by Wang, Shizun, et al. “SamplingAug: On the Importance of Patch Sampling Augmentation for Single Image Super-Resolution.” arXiv preprint arXiv: 2111.15185 (2021) needs to infer an image quality improvement model on a series of images, which results in a considerable increase in calculation cost. Further, in the case of handling a degradation process in consideration of optical characteristics of an imaging system for images and the like, the simulation for the degradation process requires a calculation cost for a series of images. In addition, if this processing is applied to a moving image, it may be difficult to represent a difficulty level originating in a motion of a moving object.

### SUMMARY

According to an aspect of the present disclosure, a data processing apparatus includes at least one processor, and at least one memory storing instructions that, upon execution of the stored instructions, cause the at least one processor to calculate a restoration error associated with restoration of a restored image sequence based on the restored image sequence restored from a degraded image sequence obtained by degrading a reference image sequence and at least one of the reference image sequence or the degraded image sequence, calculate a score according to a type of a feature amount based on the restoration error and a feature amount of a predetermined type extracted from the degraded image sequence, and extract a reference image sequence to be used for creating a data set from a series of the reference image sequences based on the score.

Further features of the present disclosure will become apparent from the following description of exemplary embodiments with reference to the attached drawings.

### BRIEF DESCRIPTION OF THE DRAWINGS

FIG. 1 illustrates an outline of an example of noise reduction processing.

FIG. 2 is a block diagram illustrating a hardware configuration example of an information processing apparatus according to a first exemplary embodiment of the present disclosure.

FIGS. 3A, 3B, and 3C are block diagrams each illustrating a functional configuration example of an image processing system according to the first exemplary embodiment.

FIGS. 4A to 4D are flowcharts each illustrating an example of processing to be performed by the image processing system.

FIGS. 5A to 5C each illustrate an example of processing for extracting a learning case.

FIGS. 6A and 6B are block diagrams each illustrating a functional configuration example of the image processing system.

FIGS. 7A to 7C are flowcharts each illustrating an example of processing to be performed by the image processing system.

### DESCRIPTION OF THE EMBODIMENTS

Exemplary embodiments of the present disclosure will be described in detail below with reference to the accompanying drawings.

In the specification and the drawings, components having substantially the same functional configurations are denoted by the same reference numerals, and repeated descriptions are omitted.

An image processing system according to a first exemplary embodiment of the present disclosure will be described below. In the present exemplary embodiment, for convenience of explanation, various examples will be described by focusing on a case where an image degraded due to noise is input and noise reduction (NR) processing for generating an image with reduced noise is applied.

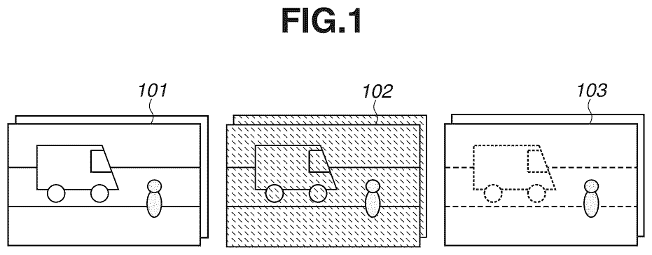

An outline of an example of NR processing will be described with reference to FIG. 1.

An image 101 schematically illustrates an image obtained before a degradation due to noise or the like occurs (hereinafter also referred to as a pre-degradation image). In the example illustrated in FIG. 1, the pre-degradation image 101 is a moving image and is a frame sequence including a plurality of frame images (still images).

In the present disclosure, a series of still images (e.g., frame images) with time-series properties, such as a frame sequence (e.g., a moving image) illustrated as the pre-degradation image 101, is also referred to as an image sequence, for convenience of explanation.

An image 102 schematically illustrates an image in which a degradation due to noise or the like occurs (hereinafter referred to as a degraded image). In the example illustrated in FIG. 1, the degraded image 102 is also a moving image and includes frame images in which a degradation has occurred in each frame image of the pre-degradation image 101.

An image 103 schematically illustrates an image generated by performing NR processing on the degraded image 102 (hereinafter also referred to as an image quality improved image). In the example illustrated in FIG. 1, the image quality improved image 103 is also a moving image and includes frame images generated as a result of performing NR processing on each frame of the degraded image 102.

In the present exemplary embodiment, assume that noise that mainly occurs in the process of converting a photon detected by an image sensor into a digital signal is treated as a noise source. Examples of the noise source include photon shot noise, readout noise, dark current noise, and a quantization error. Also, assume that such noise is modeled. Accordingly, the degraded image (e.g., degraded image 102) including noise that has occurred in the pre-degradation image (e.g., pre-degradation image 101) can be artificially generated based on a noise model as illustrated above.

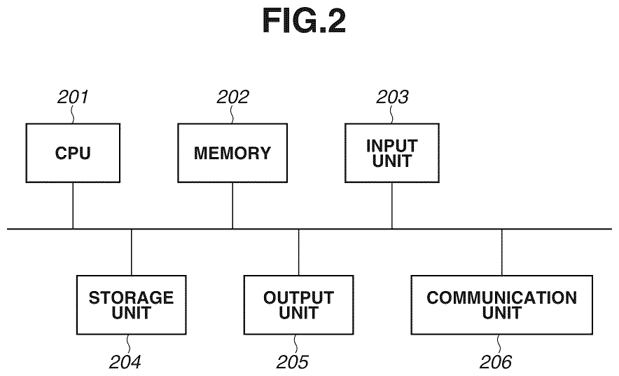

A hardware configuration example of each information processing apparatus (e.g., a data processing apparatus 1000, a learning apparatus 2000, and an image processing apparatus 3000 to be described below) constituting the image processing system according to the present exemplary embodiment will be described with reference to FIG. 2. While a configuration example of the data processing apparatus 1000 will be described with reference to FIG. 2 for convenience of explanation, a configuration substantially similar to the configuration of the data processing apparatus 1000 can be applied to the learning apparatus 2000 and the image processing apparatus 3000.

The data processing apparatus 1000 includes a central processing unit (CPU) 201, a memory 202, an input unit 203, a storage unit 204, an output unit 205, and a communication unit 206. These components of the data processing apparatus 1000 are interconnected via a bus so that the components can transmit and receive information.

The CPU 201 loads various programs stored in the storage unit 204 or the like into the memory 202 and executes the programs to thereby control the overall operation of the data processing apparatus 1000 and implement functions provided by the data processing apparatus 1000. The memory 202 is also used as a storage area for temporarily storing various data, such as a work area for the CPU 201. The memory 202 may be implemented by, for example, a random access memory (RAM). The storage unit 204 is a storage area for storing various programs and various data. The storage unit 204 may be implemented by an auxiliary storage device as typified by, for example, a read-only memory (ROM) and a hard disk drive (HDD).

The input unit 203 functions as an input interface that receives an instruction from a user. The input unit 203 may be implemented by an input device such as a mouse, a keyboard, or a touch panel.

The output unit 205 functions as an output interface for presenting various information to the user. The configuration of the output unit 205 may be changed, as needed, depending on an information output method. For example, the output unit 205 may be implemented by a display device such as a display, and may display information to be presented as an image on a predetermined display area. In another example, the output unit 205 may be implemented by an acoustic output device such as a speaker, and may output information to be presented as sound such as a voice or electronic sound.

The communication unit 206 functions as a communication interface for connecting the data processing apparatus 1000 to a network such as the Internet or a local area network (LAN). The configuration of the communication unit 206 may be changed, as needed, depending on the type of a connected network or a communication method to be applied.

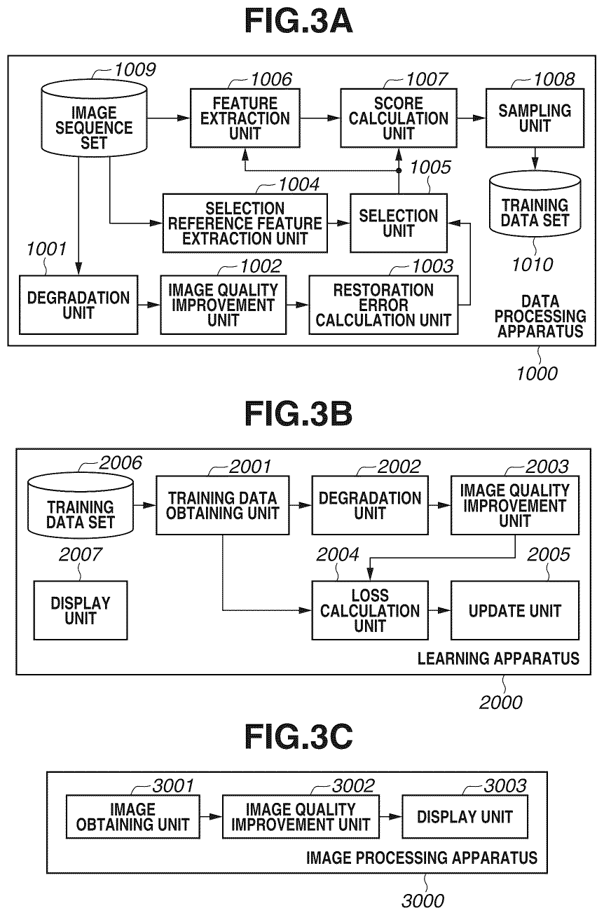

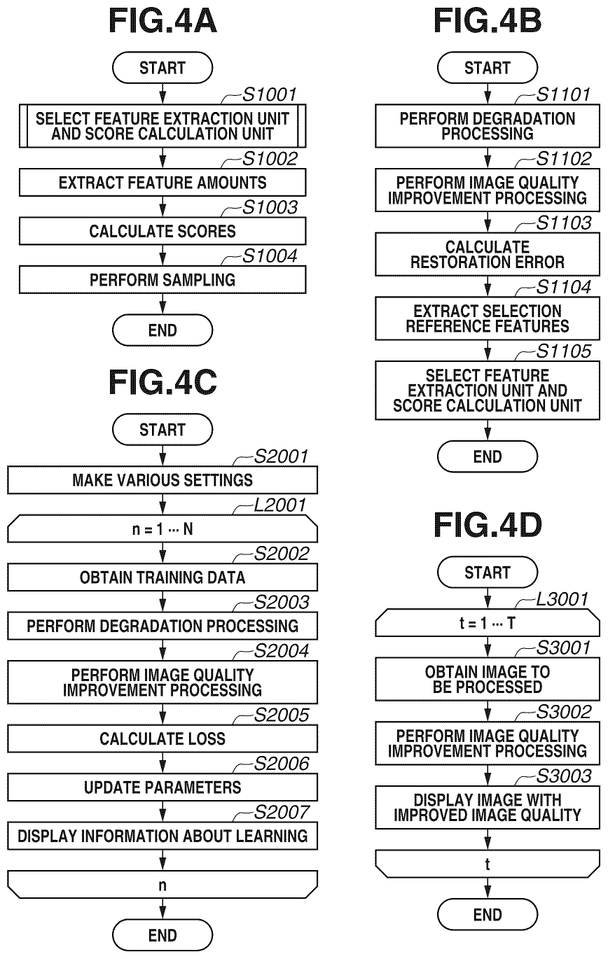

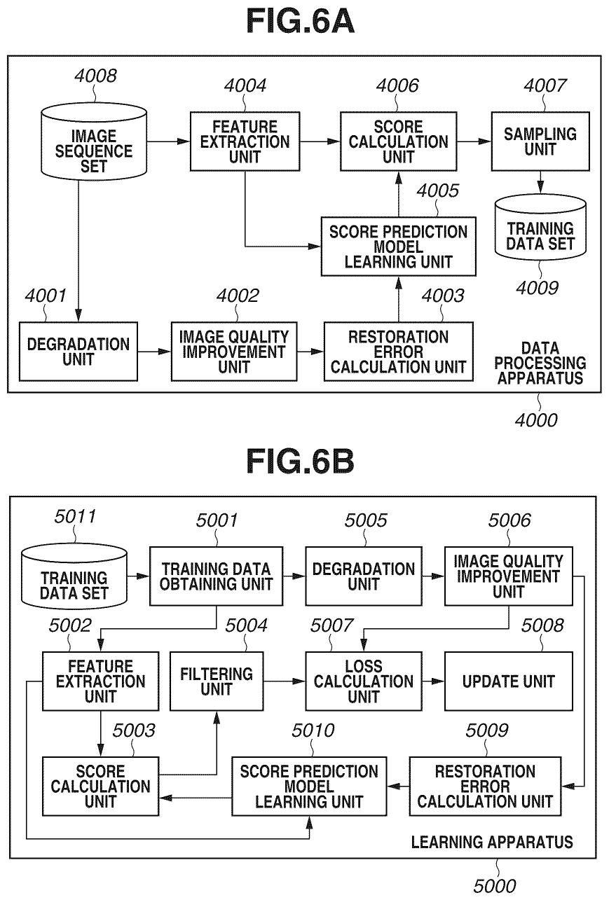

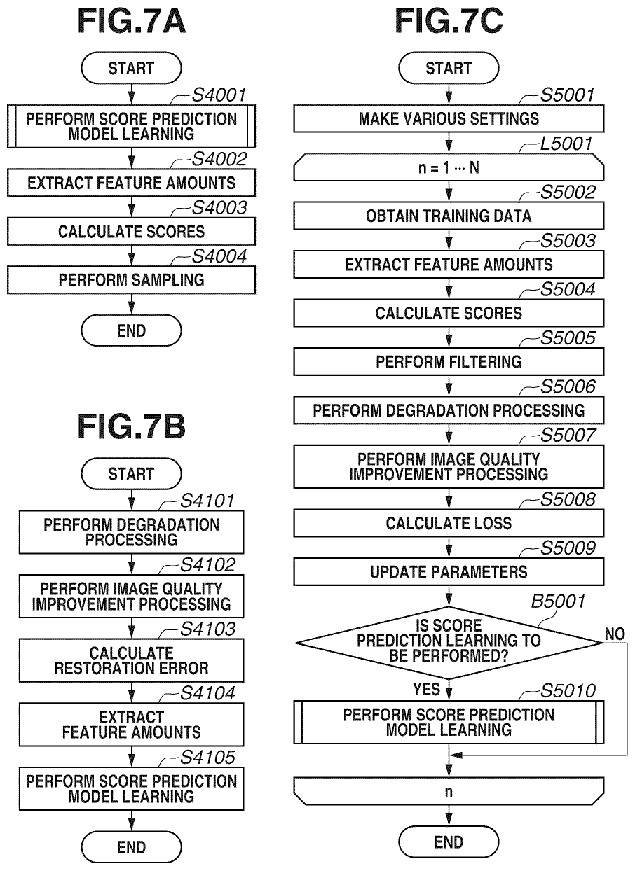

Programs stored in the storage unit 204 are loaded into the memory 202 and the CPU 201 executes the programs to thereby implement functional configurations to be described below with reference to FIGS. 3A to 3C, FIGS. 6A and 6B, and the like and processing to be described below with reference to FIGS. 4A to 4D, FIGS. 7A to 7C, and the like.

Functional configuration examples of various information processing apparatuses constituting the image processing system according to the present exemplary embodiment will be described with reference to FIGS. 3A to 3C.

FIG. 3A illustrates a functional configuration example of the data processing apparatus 1000 according to the present exemplary embodiment. The data processing apparatus 1000 includes a degradation unit 1001, an image quality improvement unit 1002, a restoration error calculation unit 1003, a selection reference feature extraction unit 1004, a selection unit 1005, a feature extraction unit 1006, a score calculation unit 1007, and a sampling unit 1008. The data processing apparatus 1000 also includes an image sequence set 1009 and a training data set 1010 as storage devices.

FIG. 3B illustrates a functional configuration example of the learning apparatus 2000 according to the present exemplary embodiment. The learning apparatus 2000 includes a training data obtaining unit 2001, a degradation unit 2002, an image quality improvement unit 2003, a loss calculation unit 2004, an update unit 2005, and a display unit 2007. The learning apparatus 2000 also includes a training data set 2006 as a storage device.

FIG. 3C illustrates a functional configuration example of the image processing apparatus 3000 according to the present exemplary embodiment in processing to be performed during run-time. The image processing apparatus 3000 includes an image obtaining unit 3001, an image quality improvement unit 3002, and a display unit 3003.

The components of the data processing apparatus 1000, the learning apparatus 2000, and the image processing apparatus 3000 described above will be described in detail below with reference to FIGS. 4A to 4D together with processing to be described below.

An example of processing to be performed by the image processing system according to the present exemplary embodiment will be described with reference to FIGS. 4A to 4D. First, an example of processing to be performed by the data processing apparatus 1000 according to the present exemplary embodiment will be described with reference to FIG. 4A by focusing on processing for creating a data set to be used for model learning.

In step S1001, the selection unit 1005 selects the feature extraction unit 1006 and the score calculation unit 1007, which are used for model learning, using at least some of a series of image sequences stored in the image sequence set 1009.

The processing of step S1001 will be described in detail below with reference to FIG. 4B. Assume that the image sequence set 1009 includes a plurality of image sequences composed of a plurality of temporally continuous frame images (in other words, a series of still images with time-series properties). In the present exemplary embodiment, assume that each image sequence has an arbitrary frame length and is composed of a single scene, for convenience of explanation. However, this definition is not intended to limit the configuration of each image sequence to be processed by the image processing system according to the present exemplary embodiment. In other words, the image sequences to be processed may include image sequences with the same frame length independently of the scene of a subject. Such an image sequence may be hereinafter also referred to as a scene. As an image sequence (scene) to be processed in step S1001, some of a series of image sequences included in the image sequence set 1009 are applied.

In step S1101, the degradation unit 1001 obtains some of the series of image sequences stored in the image sequence set 1009, and executes degradation processing by simulation on the image sequence. In the present exemplary embodiment, assume that noise is added as the degradation to the obtained image sequence. In the processing of step S1101, an image sequence to be input corresponds to the image sequence illustrated as the pre-degradation image 101 in the example illustrated in FIG. 1, and the image sequence corresponds to an example of a “reference image sequence”. An image sequence to be output corresponds to an image sequence illustrated as the degraded image 102 in the example illustrated in FIG. 1, and the image sequence corresponds to an example of a “degraded image sequence”.

In step S1102, the image quality improvement unit 1002 performs image quality improvement processing on the degraded image sequence created in step S1101 to thereby generate an image with improved image quality. As described above, in the present exemplary embodiment, assume that NR processing is applied as image quality improvement processing. The NR processing applied in step S1102 may desirably have characteristics closer to those of the NR processing applied during run-time by the image processing apparatus 3000. However, NR processing with characteristics closer to those of the processing to be performed during run-time is not available in some cases. Accordingly, in this case, appropriate alternative processing (e.g., NR processing based on rules that do not use machine learning) may be applied.

In the present exemplary embodiment, an NR model implemented by a neural network is used as processing to be performed during run-time. Accordingly, if an NR model trained using some training data set is available, the NR model may be used for image quality improvement processing in step S1102.

An image quality improved image sequence to be output as a result of NR processing corresponds to the image sequence illustrated as the image quality improved image 103 in the example illustrated in FIG. 1, and the image sequence corresponds to an example of a “restored image sequence”.

In step S1103, the restoration error calculation unit 1003 calculates a restoration error generated between the pre-degradation image and the restored image when the degradation occurring in the image is restored based on the pre-degradation image sequence, the degraded image sequence, the image quality improved image sequence, and the like.

The restoration error is an error to be used as an index of a learning effect. In the present exemplary embodiment, assume that a quantitative image quality index, such as Peak Signal to Noise Ratio (PSNR) or Structural SIMilarity (SSIM), is used as the restoration error.

PSNR is calculated using the pre-degradation image and the image quality improved image. An average value is calculated based on time and the calculated average value is used as PSNR. For example, PSNR is calculated based on the following relational expression.

$${PSNR}_{NR} = 1 / N \cdot {Σ}_{n} PSNR ( {I}_{n}^{( NR )} , {I}_{n}^{( GT )} ) \qquad ( 1 )$$

In the above relational expression, PSNR ( ) represents a function for calculating PSNR, and a generally used known expression is applied. In the relational expression, “N” represents the length of an image sequence, “n” represents an index of the image sequence with respect to time, “In (NR)” represents an n-th high image quality image, and “In (GT)” represents an n-th pre-degradation image.

By focusing on an improvement width of the image quality of the image quality improved image using the degraded image as an input, APSNR to be described below based on PSNR of the degraded image may be used as the restoration error.

$${PSNR}_{Noisy} = 1 / N \cdot {Σ}_{n} PSNR ( {I}_{n}^{( Noisy )} , {I}_{n}^{( GT )} ) \qquad ( 2 )$$

$$Δ PSNR = {PSNR}_{NR} \cdot {PSNR}_{Noisy}$$

In this case, a relative improvement width of PSNR from the degraded image is evaluated as APSNR. Accordingly, the improvement width is effective in creating training data effective for improvement in the improvement width.

Alternatively, an evaluation index focusing on a motion of a moving object may also be used. As an example of such an evaluation index, an inter-frame difference PSNR represented by the following relational expression may be used.

$${PSNR}_{framediff} = 1 / N \cdot {Σ}_{n} {PSNR}_{mask} ( {I}_{n}^{( NR )} - {I}_{n - 1}^{( NR )} , {I}_{n}^{( GT )} - {I}_{n - 1}^{( GT )} ) \qquad ( 3 )$$

In the above relational expression, PSNRₘₐₛₖ( ) represents a function for calculating PSNR when an area where the value of the inter-frame difference in ground truth (GT) is closer to zero (i.e., an area with no motion) is masked and excluded from a calculation target. The value of PSNR on an inter-frame difference image is calculated only on a limited area, and the reproducibility of the image quality of a moving object is evaluated as a result of the calculation.

Also, ΔPSNR for the inter-frame difference PSNR may be calculated.

In addition to PSNR, evaluation values such as SSIM, a distance L2, and a distance L1, or a combination of these evaluation values may be applied as the restoration error, and may be used as the index of the learning effect.

In step S1104, the selection reference feature extraction unit 1004 extracts selection reference features. The selection reference features correspond to a plurality of feature amounts to be used as a reference when the selection unit 1005 selects feature amounts indicating features of an image to be used for creating a data set in step S1002.

As a specific example, considering that a motion of a moving object in a moving image highly contributes to the learning effect in the improvement of the image quality of the image, an optical flow that represents the motion of the moving object as a vector field may be calculated as one selection reference feature.

In another example, the level of difficulty in noise reduction in an area with texture within the image tends to be higher than that in an area with no texture within the image. Accordingly, a feature amount representing the presence or absence of texture may be used as one selection reference feature.

As an example of such feature amounts, an edge detection result obtained by a Sobel filter or a Canny method, a spatial frequency analysis result obtained by a two-dimensional Fast Fourier Transform (FFT), or the like may be calculated as one selection reference feature.

As described above, the selection reference features to be extracted by the selection reference feature extraction unit 1004 include a feature amount based on a spatiotemporal frequency characteristic of an image sequence, such as a moving image, including at least time-series properties.

A feature amount with a weight sufficiently lower (lower calculation cost) than that when image quality improvement processing is executed may be applied as the feature amount to be used as one selection reference feature.

In step S1105, the selection unit 1005 selects each of the feature extraction unit 1006 and the score calculation unit 1007 to be used for creation of a data set from among a plurality of candidates.

The score calculation unit 1007 is a component for scoring the feature amount extracted by the feature extraction unit 1006 based on a predetermined reference.

The selection unit 1005 determines a score calculation method for each of the plurality of selection reference features obtained in step S1104, and selects the feature extraction unit 1006 and the score calculation unit 1007 to be used for creation of a data set based on scores calculated by the score calculation methods.

An example of the score calculation method depending on the feature amount will now be described.

For example, in an optical flow, a motion of a subject in two frames adjacent to a previous frame and a current frame is represented as a vector field on a two-dimensional plane represented by a vertical direction (Y-axis) and a perpendicular direction (X-axis) on an image plane. In this case, for example, the sum of magnitudes of vectors may be used as a score for the current frame to represent the magnitude of the motion of the moving object. An average value of scores for each frame in the entire image sequence may be calculated in a time direction, and the calculated average value may be used as a score for the scene.

In another example, in the case of applying an edge detection result obtained by the Sobel filter or the Canny method as the feature amount, the sum of edges within each frame may be calculated and the calculated value may be used as a score for the frame.

An average value of scores for each frame on each scene may be calculated and the calculated average value may be used as a score for the scene.

In another example, in the case of applying a spatial frequency as the feature amount, a value obtained by integrating high-frequency components in the time direction may be used as a score for each frame. An average value of scores for each frame may be calculated and the calculated average value may be used as a score for the scene.

As described above, the selection unit 1005 calculates a correlation coefficient between the score for the scene calculated for each selection reference feature and the restoration error for each scene calculated in step S1103, and selects the feature extraction unit 1006 and the score calculation unit 1007 based on the magnitude of the correlation.

Among the indices for the learning effect, a greater value of PSNR (including ΔPSNR and the inter-frame difference PSNR) or SSIM indicates that an image quality closer to the GT can be reproduced. Accordingly, it can be considered that a greater value of PSNR or SSIM indicates a scene with a lower difficulty level in image restoration and a lower learning effect.

As the value of the distance L1 or the distance L2 increases, the distance from the GT increases.

Accordingly, it can be considered that a greater value of the distance L1 or the distance L2 indicates a scene with a higher difficulty level in image restoration and a higher learning effect.

Based on the above-described characteristics, a negative correlation with the score for each scene calculated based on the selection reference features is indicated for PSNR and SSIM in the correlation coefficients described above. Further, a positive correlation with the score for each scene calculated based on the selection reference features is indicated for the distance L1 and the distance L2. When any one of the correlation coefficients described above is applied, the selection unit 1005 may select the feature extraction unit 1006 and the score calculation unit 1007 with a higher correlation based on the magnitude (absolute value) of the correlation.

The processing of step S1001 illustrated in FIG. 4A has been described in detail above with reference to FIG. 4B. This processing allows the feature extraction unit 1006 and the score calculation unit 1007 to be used for creation of a data set to be selected using some of the image sequences stored in the image sequence set 1009.

Referring again to FIG. 4A, the processing in the flowchart will be further described.

In step S1002, the feature extraction unit 1006 extracts feature amounts for a series of image sequences stored in the image sequence set 1009. The feature amounts to be extracted in this case correspond to feature amounts depending on the feature extraction unit 1006 (feature amount extraction method) selected in step S1001. Examples of the feature amounts to be extracted include an optical flow, an edge detection result obtained by the Sobel filter or the Canny method, and a spatial frequency as described above. These feature amounts are merely examples and the type of the feature amount to be applied is not particularly limited as long as the feature amount can be extracted from an image sequence and the correlation between the feature amount and the restoration error for each scene can be evaluated.

In step S1003, the score calculation unit 1007 calculates two types of scores, i.e., a score for each frame and a score for each scene in the series of image sequences from which the feature amounts are extracted in step S1002. In this case, the score calculation method depending on the score calculation unit 1007 selected in step S1001 is used.

For example, if an optical flow is applied as the feature amount, the score calculation unit 1007 calculates the score for each frame by summing up the absolute values of vectors in the optical flow of each frame obtained in step S1002. Further, the score calculation unit 1007 calculates an average value of the scores for each frame on each scene as the score for the scene.

Also, in a case where a feature amount other than an optical flow is selected, the score for each frame and the score for each scene are calculated by the score calculation method depending on the type of the target feature amount.

In step S1004, the sampling unit 1008 extracts a learning case (in other words, an image sequence to be used for creation of a data set) based on the score calculated in step S1003.

A method for extracting a learning case in two steps will be described below as an example of the learning case extraction method.

In a first step, the sampling unit 1008 determines the total number of samples for image sequences to be extracted in advance and performs normalization processing so that the score for each scene can represent a value (e.g., a value in a range from 0.0 to 1.0) indicating a relative ratio to a maximum value that can be taken by the score. In addition, the sampling unit 1008 stochastically determines the number of samples for image sequences to be obtained from each scene using the value obtained by normalizing the scores for each scene as the probability.

Next, in a second step, the sampling unit 1008 performs normalization processing on the scores for each frame in each scene, like in the first step. In addition, the sampling unit 1008 stochastically determines a location where a frame image in each scene is to be extracted using the value obtained by normalizing the scores for each frame in each scene as the probability.

The learning case to be finally extracted (sampled) by the above-described processing is an image sequence with a predetermined frame length (e.g., 10 frames or 20 frames) that is shorter than the frame length of the target image sequence.

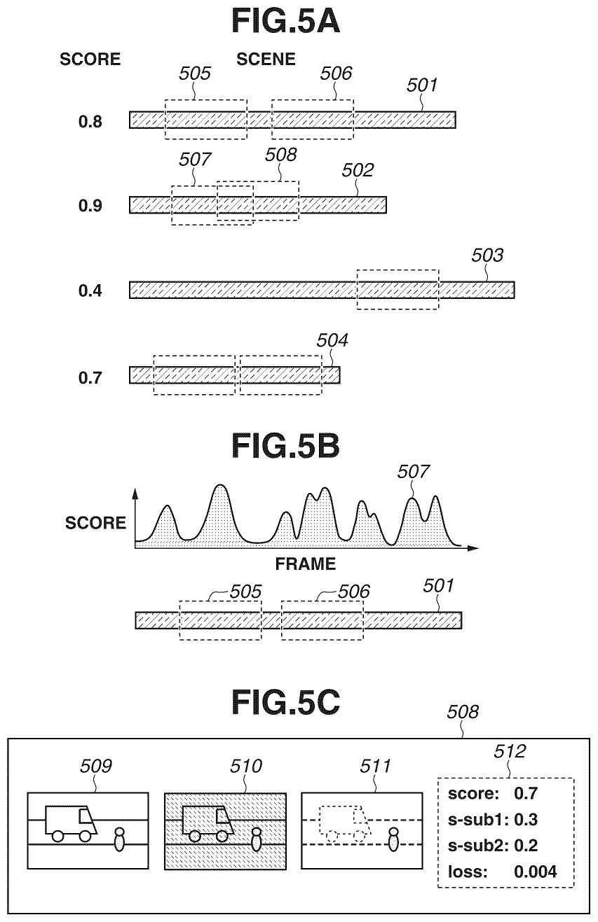

An example of the first-step processing in the learning case extraction processing to be performed by the sampling unit 1008 will now be described in more detail with reference to FIG. 5A.

Areas 501, 502, 503, and 504 indicate scenes (image sequences) stored in the image sequence set 1009, and the scores for the scenes 501, 502, 503, and 504 are 0.8, 0.9, 0.4, and 0.7, respectively. The sampling unit 1008 stochastically determines the number of samples for the image sequences to be extracted as samples for each scene using the value obtained by normalizing the scores as described above as the probability. In the example illustrated in FIG. 5A, the sampling unit 1008 sets the total number of samples to “7”, and determines the number of samples for the image sequences to be extracted from the scenes 501, 502, 503, and 504 to be “two samples”, “two samples”, “one sample”, and “two samples”, respectively.

In addition, the sampling unit 1008 extracts image sequences as samples from the scene based on the number of samples determined for each scene and the location in the scene. For example, in the example illustrated in FIG. 5A, the sampling unit 1008 extracts image sequences with a predetermined frame length as samples for the scene 501 from locations 505 and 506 each indicated by a broken-line rectangle. Further, the sampling unit 1008 extracts image sequences with a predetermined frame length as samples for the scene 502 from locations 507 and 508 each indicated by a broken-line rectangle.

Next, an example of the second-step processing in the learning case extraction processing to be performed by the sampling unit 1008 will be described in more detail with reference to FIG. 5B. Objects 501, 505, and 506 illustrated in FIG. 5B are respectively identical to the objects 501, 505, and 506 illustrated in FIG. 5A. In a graph 507, scores calculated for each frame of the scene 501 are plotted in time series. In the graph 507, a horizontal axis represents time and a vertical axis represents a score. As illustrated in FIG. 5B, the locations of image sequences to be extracted as samples are stochastically determined using the value obtained by normalizing the scores for each frame as described above as the probability. For example, in the example illustrated in FIG. 5B, the value (probability) obtained by normalizing the scores for each frame in the locations 505 and 506 (location corresponding to the center of a range indicated by a broken-line rectangle) is higher than the other locations.

The method of extracting image sequences from each scene as described above (sampling method) is merely an example, and the method is not particularly limited as long as image sequences with a higher correlation with the score for each scene calculated based on the selection reference features can be extracted from the scene.

As a specific example, after the first-step processing described above is executed, the locations from which image sequences are extracted from each scene in the second-step processing may be determined to be a uniform distribution.

In another example, the second-step processing may be applied to a series of scenes without executing the first-step processing. Specifically, scores for each frame in a series of image sequences may be normalized as described above and a number of locations corresponding to a predetermined total number of samples in the scene in which image sequences are extracted as samples may be determined using the normalized value of the scores as the probability.

In each of the methods described above, the number of frames of image sequences to be extracted from a target scene is determined in advance, but instead may be determined in the process of a series of processing without determining the number of frames in advance. As a specific example, image sequences may be stochastically extracted from each scene, and the extraction of image sequences from the scene may be terminated when the sum of integrated scores reaches a predetermined threshold.

In the above-described method, the locations (extraction ranges) where image sequences are extracted from a target scene may at least partially overlap each other, for example, as indicated by the areas 507 and 508 illustrated in FIG. 5A. In this case, a learning case (image sequence) with a higher score may be extracted by applying non-maximum suppression (NMS) to a plurality of extraction locations (extraction ranges) overlapping each other.

A series of learning cases (image sequences) extracted by executing a series of processing illustrated in FIG. 4A as described above is stored in the training data set 1010.

An example of processing to be executed by the data processing apparatus 1000 according to the present exemplary embodiment has been described above with reference to FIGS. 4A and 4B by focusing on processing for creating a data set to be used for model learning.

Next, an example of processing to be performed by the learning apparatus 2000 according to the present exemplary embodiment will be described with reference to FIG. 4C especially by focusing on processing for model learning.

In step S2001, the learning apparatus 2000 makes various settings for model learning. In the present exemplary embodiment, assume that an NR model is applied to the image quality improvement unit 2003 as a neural network and a stochastic gradient descent is applied as a learning method for the NR model. In the processing of step S2001, a mini-batch size (the number of pieces of data constituting a mini-batch) to be described below, a learning coefficient, a parameter for the solver of the stochastic gradient descent, and the like are set.

A loop L2001 is a loop of iteration for the stochastic gradient descent. A preliminarily set value may be applied as a maximum value N of a variable n (variable indicating the number of times of loop) related to conditions for terminating a series of processing indicated by the loop L2001. In another example, conditions for a loss to be described below may be applied in place of the number of times of loop as the conditions for terminating the series of processing indicated by the loop L2001. As a specific example, control processing for terminating the series of processing indicated by the loop L2001 when a loss calculated in step S2005 is less than or equal to a threshold may be applied.

In step S2002, the training data obtaining unit 2001 obtains data to be used for model learning from the training data set 2006. The training data set 2006 includes the image sequence with the predetermined frame length created in the series of processing described above with reference to FIG. 4A. The image sequence stored in the training data set 2006 corresponds to the image sequence (pre-degradation image sequence) in which noise is extremely small as indicated by the pre-degradation image 101 illustrated in FIG. 1.

In step S2002, the training data obtaining unit 2001 obtains a number of image sequences corresponding to the mini-batch size set in step S1001.

In step S2003, the degradation unit 2002 degrades the pre-degradation image sequence obtained in step S2002. In the present exemplary embodiment, assume that the degradation unit 2002 adds artificial noise as a degradation to the pre-degradation image sequence. As described above, noise is modeled. Accordingly, the degradation unit 2002 generates noise from a noise model and adds the noise to the pre-degradation image sequence to thereby generate the degraded image sequence in which the noise occurs.

In step S2004, the image quality improvement unit 2003 performs restoration processing for restoring the degradation due to noise or the like occurring in the image sequence, such as image quality improvement processing, on the degraded image sequence generated in step S2003. The NR model for performing NR processing is a neural network. In the processing of step S2004, forward-propagation processing is performed using the degraded image sequence as an input and using the image quality improved image sequence as an output.

The NR model performs NR processing on a moving image. Typically, there are three types of neural networks to perform image processing on a moving image as described below. A first type is a sliding window type having a structure with a plurality of frame inputs and a plurality of frame outputs. A second type is a recurrent type having a recurrent structure with one frame input and one frame output. A third type is a hybrid type that is a combination of the first type and the second type, and has a recurrent structure with a plurality of frame inputs and a plurality of frame outputs. In any case, an image sequence with a predetermined frame length constituting a mini-batch is used in the processing of step S2004, and any one of the three types of neural networks as described above is used to perform more appropriate forward-propagation processing.

In step S2005, the loss calculation unit 2004 calculates a loss. In this case, a loss L1 and a loss L2 may be used as the loss using the pre-degradation image sequence as a GT and the image quality improved image sequence as a prediction. In addition, regularization such as total variation regularization may be used. If there is a plurality of losses, the loss calculation unit 2004 integrates the plurality of losses with an appropriate weight and uses the calculation result as a final loss.

In step S2006, the update unit 2005 updates parameters for the image quality improvement unit 2003. In the present exemplary embodiment, the update unit 2005 determines the amount of update of parameters in each layer of the NR model by the error back-propagation learning method based on the loss calculated in step S2005, and updates the parameters for the NR model.

In step S2007, the display unit 2007 displays information about learning. As a specific example, the training data set 2006 includes the score for the pre-degradation image sequence. In step S2007, the display unit 2007 displays the score in association with each of the pre-degradation image sequence, the degraded image sequence, and the image quality improved image sequence on a predetermined display area. In addition, the display unit 2007 may display the loss and the score for a feature amount other than the selected feature amount for reference.

FIG. 5C illustrates an example of information to be displayed on the display unit 2007. A display area 508 schematically illustrates a display area to be displayed on a part of a display screen. On the display area 508, a pre-degradation image 509, a degraded image 510, and an image quality improved image 511 are displayed. The display area 508 includes a display area 512 for displaying scores associated with the pre-degradation image 509, the degraded image 510, and the image quality improved image 511, respectively, scores for feature amounts other than the selected feature amount, a loss, and the like.

An example of processing to be performed by the learning apparatus 2000 according to the present exemplary embodiment has been described above with reference to FIG. 4C especially by focusing on processing associated with model learning. In the series of processing described above, parameters to be used for the image quality improvement unit 3002 during run-time are trained.

Next, an example of processing to be performed during run-time by the image processing apparatus 3000 according to the present exemplary embodiment will be described with reference to FIG. 4D.

A loop L3001 is a loop for time in NR processing on a moving image. If a frame length for a moving image on which NR processing is to be performed can be set in advance, the frame length is set for a maximum value T of a variable t of time for conditions for terminating the series of processing indicated by the loop L3001. If the frame length is not set in advance, like in a video image to be streamed in real time, the loop is executed until separately set processing termination conditions (e.g., conditions for terminating a streaming video reproduction or the like) are satisfied.

In step S3001, the image obtaining unit 3001 obtains an image to be processed. The image obtaining unit 3001 obtains a number of images corresponding to the number of frames (e.g., still images of frame images or the like) compatible with an NR model method for performing NR processing, and supplies the obtained images to the subsequent-stage image quality improvement unit 3002.

For example, if the NR model is the sliding window type or the hybrid type with a plurality of frame inputs, the image obtaining unit 3001 obtains a number of image sequences corresponding to a plurality of frames matching the number of input frames of the model. In another example, if the recurrent type with one frame input is used, the image obtaining unit 3001 obtains an image corresponding to one frame.

Assume that a frame rate of each image obtained in the processing of step S3001 is lower than the throughput of the NR model. Each image obtained in the processing of step S3001 is data to be subjected to NR processing and is a degraded image (sequence).

In step S3002, the image quality improvement unit 3002 performs NR processing on the degraded image (sequence) obtained in step S3001, thereby creating an image (image sequence) with improved image quality. As described above, examples of the input/output configuration of the NR model to be applied to NR processing depending on the method include a configuration with a plurality of frame inputs and a plurality of frame outputs and a configuration with one frame input and one frame output. Accordingly, the image quality improvement unit 3002 controls NR processing to be executed by a number of times corresponding to the number of frames depending on the target method.

In step S3003, the display unit 3003 displays the image quality improved image created in step S3002 on the predetermined display area.

If the NR model is the sliding window type, a plurality of frames is output in each inference processing. In this case, the display unit 3003 may display frames while performing buffering to switch the frames at regular intervals.

Further, the display unit 3003 controls the frame rate for the display of the image quality improved image to match the frame rate of each image obtained in step S3001.

An example of processing to be performed during run-time by the image processing apparatus 3000 according to the present exemplary embodiment has been described above with reference to FIG. 4D by focusing on the NR processing using the image quality improvement unit 2003 trained by the learning apparatus 2000.

The configurations of the data processing apparatus 1000, the learning apparatus 2000, and the image processing apparatus 3000 described above with reference to FIGS. 3A to 3C are merely examples, and the configurations of the data processing apparatus 1000, the learning apparatus 2000, and the image processing apparatus 3000 are not limited as long as the functions of the components of each apparatus can be implemented. For example, at least any one of the data processing apparatus 1000, the learning apparatus 2000, and the image processing apparatus 3000 may be implemented by causing a plurality of apparatuses or services to operate in cooperation. As a specific example, the functions of the degradation unit 1001, the image quality improvement unit 1002, and the restoration error calculation unit 1003 in the components of the data processing apparatus 1000 may be implemented by an external apparatus different from the data processing apparatus 1000. In another example, two or more of the data processing apparatus 1000, the learning apparatus 2000, and the image processing apparatus 3000 may be implemented by a single apparatus. As a specific example, the functions of the data processing apparatus 1000 and the learning apparatus 2000 may be implemented by a single apparatus.

As described above, the image processing system according to the present exemplary embodiment collects learning cases based on a motion of a moving object that affects the level of difference in degradation restoration processing such as image quality improvement processing to be performed on a moving image, thereby making it possible to construct a training data set with a higher learning effect. Consequently, favorable learning processing for degradation restoration processing can be performed regardless of a motion of a moving object in degradation restoration processing on an image sequence such as a moving image, and degradation restoration processing such as image quality improvement processing can be executed using a trained model.

### Modified Example of First Exemplary Embodiment

While the first exemplary embodiment described above illustrates an example where NR processing is applied as an example of degradation restoration processing to be applied to the image quality improvement unit 1002, the processing to which the present exemplary embodiment is applied is not particularly limited.

For example, super-resolution processing may be applied as degradation restoration processing. Also, in the case of performing super-resolution processing on a moving image, it is considered that the alignment is important under a situation where an object is moving and the motion of the moving object affects the difficulty level in learning (the difficulty level increases as the motion increases). Accordingly, if a training data set is constructed based on a motion of a moving object by applying the technique according to the present exemplary embodiment, the advantageous effect of improving the image restoration accuracy in super-resolution processing on a moving image can be expected.

A second exemplary embodiment of the present disclosure will be described below. In the first exemplary embodiment described above, a plurality of types of feature amounts are extracted as selection reference features, and feature amounts to be used for creation of a data set and the score calculation method are selected based on the correlation between the score for each feature amount and the restoration error. On the other hand, to obtain the score calculation unit suitable for sampling a data set with a higher learning effect, a model trained to directly predict the restoration error from the feature amounts can be used instead of using the selection method. In the present exemplary embodiment, an example of the technique using this model will be described.

A functional configuration example of a data processing apparatus according to the second exemplary embodiment will be described with reference to FIG. 6A.

A data processing apparatus 4000 includes a degradation unit 4001, an image quality improvement unit 4002, a restoration error calculation unit 4003, a feature extraction unit 4004, a score prediction model learning unit 4005, and a sampling unit 4007. The data processing apparatus 4000 also includes an image sequence set 4008 and a training data set 4009 as storage devices.

The above-described components of the data processing apparatus 4000 will be described in detail together with processing to be described below with reference to FIGS. 7A and 7B.

An example of processing to be performed by the data processing apparatus 4000 according to the present exemplary embodiment will be described below with reference to FIG. 7A by focusing on processing for creating a data set to be used for model learning. The following description will be made by mainly focusing on differences from the first exemplary embodiment, and detailed descriptions of the components that are substantially similar to those of the first exemplary embodiment will be omitted.

In step S4001, the score prediction model learning unit 4005 performs learning processing on a score prediction model for predicting a score based on feature amounts extracted from image sequences using at least some of a series of image sequences stored in the image sequence set 4008.

The processing of step S4001 will be described in detail below with reference to FIG. 7B.

In step S4101, the degradation unit 4001 obtains some of the series of image sequences stored in the image sequence set 4008 and executes processing of degrading the image sequence. Detailed descriptions of processing substantially similar to the processing of step S1101 illustrated in FIG. 4B will be omitted.

Similarly, as processing of steps S4102 and S4103, processing substantially similar to the processing of steps S1102 and S1103 illustrated in FIG. 4B is executed. In this case, the image quality improvement unit 4002 and the restoration error calculation unit 4003 respectively correspond to the image quality improvement unit 1002 and the restoration error calculation unit 1003 illustrated in FIG. 3A. Thus, the image quality improved image is generated from the degraded image sequence and the restoration error is calculated based on the pre-degradation image sequence, the degraded image sequence, the image quality improved image sequence, and the like.

In step S4104, the feature extraction unit 4004 extracts feature amounts (selection reference features) from the target image sequence, like in the processing of step S1104 illustrated in FIG. 4B.

In the first exemplary embodiment, an optical flow between adjacent frames is calculated, edges in each frame are detected, and the calculated feature amounts are summed up within the frame, thereby calculating the score of the scalar value for each frame.

In the processing of step S4104, the feature extraction unit 4004 calculates multiple-dimensional scores for each frame by an arithmetic operation such as averaging, distribution, or conversion into a histogram, in addition to the summation of the calculated feature amounts.

The feature extraction unit 4004 calculates multiple-dimensional scores based on a plurality of types of feature amounts, like in the optical flow and edge detection. The feature extraction unit 4004 connects the calculated multiple-dimensional scores and uses the connected scores as multiple-dimensional feature amounts for each frame.

In step S4105, the score prediction model learning unit 4005 performs learning processing on a score prediction model. Specifically, the score prediction model learning unit 4005 performs model learning processing to predict a restoration error (objective variable) as an index of the learning effect based on feature amounts (explanatory variables). As the feature amounts, the multiple-dimensional feature amounts extracted in step S4104 are applied and the index such as PSNR calculated in step S4103 is applied as the restoration error.

As the model to be applied, a regression model such as polynomial regression, or a neural network such as multilayer-perceptron may be used. In any case, the model may be optimized so that the difference between an output from the prediction model and an objective variable can be minimized.

The processing of step S4001 illustrated in FIG. 7A has been described in detail above with reference to FIG. 7B. The processing of step S4001 is executed using some of the data stored in the image sequence set 4008. On the other hand, subsequent processing is executed on a series of data stored in the image sequence set 4008.

Referring again to FIG. 7A, the processing in the flowchart is further described.

In step S4002, the feature extraction unit 4004 extracts multiple-dimensional feature amounts for each frame from the series of image sequences stored in the image sequence set 4008. The contents of processing for extracting the multiple-dimensional feature amounts from the image sequences are substantially similar to those of the processing of step S4104 illustrated in FIG. 7B, and thus detailed descriptions thereof will be omitted.

In step S4003, the score calculation unit 4006 calculates scores for the series of image sequences stored in the image sequence set 4008.

Specifically, the score calculation unit 4006 obtains the score for each frame using the multiple-dimensional feature amounts for each frame extracted in step S4002 as an input to the score prediction model trained in step S4105 and using the score prediction model as an output.

The above-described score is calculated for each frame. Depending on the processing to be performed by the subsequent-stage sampling unit 4007, an average value of the scores for a plurality of frames within the image sequence is calculated, and the calculated average value is used as the score for the scene.

In step S4004, the sampling unit 4007 performs sampling of a learning case from the series of image sequences stored in the image sequence set 4008. The processing of step S4004 is substantially similar to the processing of step S1004 illustrated in FIG. 4A, except for the difference in the score to be used. Specifically, the score used in the processing of step S4004 is a predicted value of the index of the learning effect output from the prediction model in step S4003. The processing of step S4004 is substantially similar to the processing of step S1004, except for the difference in the score, and thus detailed descriptions thereof will be omitted.

A functional configuration example and a processing example of the data processing apparatus 4000 according to the present exemplary embodiment have been described above with reference to FIGS. 6A, 7A, and 7B.

Details of model learning processing and processing to be performed during run-time are substantially similar to those of the first exemplary embodiment, and thus detailed descriptions thereof are omitted.

As described above, the image processing system according to the present exemplary embodiment is configured to predict an index of the learning effect and construct a training data set with a higher learning effect using light feature amounts such as an optical flow or edge detection. Consequently, favorable learning processing for degradation restoration processing can be performed regardless of a motion of a moving object in degradation restoration processing on an image sequence such as a moving image, and degradation restoration processing such as image quality improvement processing can be executed using a trained model.

A third exemplary embodiment of the present disclosure will be described below. The first and second exemplary embodiments described above illustrate an example where a training data set is created prior to learning processing on the NR model to be subjected to NR processing. In this case, it may be desirable to re-create a training data set if the image quality improvement unit used in the data processing apparatus greatly differs from the image quality improvement unit used in the learning apparatus in the learning process.

In view of the above-described circumstances, the third exemplary embodiment illustrates an example where learning processing on a score prediction model is performed during learning processing on the NR model, and sampling of a learning case is dynamically performed using the score prediction model that is updated as needed.

A functional configuration example of a learning apparatus according to the third exemplary embodiment will be described with reference to FIG. 6B. A learning apparatus 5000 includes a training data obtaining unit 5001, a feature extraction unit 5002, a score calculation unit 5003, a filtering unit 5004, a degradation unit 5005, an image quality improvement unit 5006, a loss calculation unit 5007, an update unit 5008, a restoration error calculation unit 5009, and a score prediction model learning unit 5010. The learning apparatus 5000 also includes a training data set 5011 as a storage device.

The components of the learning apparatus 5000 described above will be described in detail together with processing to be described below with reference to FIG. 7C.

An example of processing to be performed by the learning apparatus 5000 according to the present exemplary embodiment will be described with reference to FIG. 7C especially by focusing on processing for model learning. The following description will be made by mainly focusing on differences from the first and second exemplary embodiments, and detailed descriptions of components similar to those of the first and second exemplary embodiments will be omitted.

In step S5001, the learning apparatus 5000 makes various settings for model learning. In the present exemplary embodiment, a score prediction mode is used in step S5004 and initial values for the score prediction model are set in step S5001. It may be desirable to use trained parameters as initial values. However, random initial values can also be used to perform learning processing on a target model.

In the present exemplary embodiment, two types of batches with different sizes, respectively, are used. One of the batches is a stochastic gradient descent mini-batch, and the other of the batches is a batch larger than the mini-batch. In the processing of step S5005, filtering of image sequences (extraction of some of image sequences with a score that satisfies a predetermined condition from a series of image sequences as parameters) is performed based on the score. In this filtering processing, the batch obtained before filtering corresponds to the batch larger than the mini-batch, and the batch obtained after filtering corresponds to the mini-batch. Accordingly, in the following description, the size (size indicating the number of pieces of data) of the batch obtained after filtering (mini-batch) is also referred to as a mini-batch size, and the size of the batch obtained before filtering is also referred to as pre-filtering size, for convenience of explanation.

The other setting items are substantially similar to those described in the processing of step S2001 with reference to FIG. 4C in the first exemplary embodiment, and thus detailed descriptions thereof will be omitted.

A loop L5001 is a loop of iteration for the stochastic gradient descent. The loop L5001 is substantially similar to the loop L2001 illustrated in FIG. 4C, and thus detailed descriptions thereof will be omitted.

In step S5002, the training data obtaining unit 5001 obtains image sequences stored in the training data set 5011. The training data set 5011 includes image sequences with an appropriate frame length for learning processing on the NR model to improve the image quality of a moving image. Each image sequence stored in the training data set 5011 corresponds to the image sequence (pre-degradation image sequence) in which noise is extremely small as indicated by the pre-degradation image 101 illustrated in FIG. 1. In step S5002, the training data obtaining unit 5001 obtains a number of image sequences corresponding to the pre-filtering size set in step S5001 from the training data set 5011.

In step S5003, the feature extraction unit 5002 extracts feature amounts (multiple-dimensional feature amounts) for the image sequences obtained in step S5002. The processing of step S5003 is substantially similar to the processing of step S4002 illustrated in FIG. 7A in the second exemplary embodiment, except that the target image sequences have a predetermined length, and thus detained descriptions thereof are omitted.

In step S5004, the score calculation unit 5003 predicts the score for each frame based on the multiple-dimensional feature amounts for the image sequences extracted in step S5003. Also, the processing of step S5004 is substantially similar to the processing of step S4003 illustrated in FIG. 7A in the second exemplary embodiment, except that the target image sequences have a predetermined sequence length, and thus detailed descriptions thereof will be omitted.

In step S5005, the filtering unit 5004 performs filtering to extract a number of image sequences corresponding to the mini-batch size from a number of image sequences corresponding to the pre-filtering size obtained in step S5002 based on the score for each image sequence calculated in step S5004.

For example, since the score for each frame in the image sequence is predicted in step S5004, the filtering unit 5004 may extract a number of image sequences corresponding to the mini-batch size in a descending order of the score for each scene obtained by summing up or averaging the scores for each frame in all frames. In another example, the filtering unit 5004 may normalize the scores for each scene so that the score can represent a value indicating a relative ratio to a maximum value that can be taken by the score, and may randomly extract a number of image sequences corresponding to the mini-batch size using the normalized value as the probability.

As described above, filtering is performed to extract a number of image sequences corresponding to the mini-batch size from the series of image sequences obtained in step S5002.

The processing of steps S5006, S5007, S5008, and S5009 is substantially similar to the processing of steps S2003, S2004, S2005, and S2006 illustrated in FIG. 4C, and thus detailed descriptions thereof will be omitted. In this case, the degradation unit 5005, the image quality improvement unit 5006, the loss calculation unit 5007, and the update unit 5008 respectively correspond to the degradation unit 2002, the image quality improvement unit 2003, the loss calculation unit 2004, and the update unit 2005 illustrated in FIG. 3B.

In step B5001, the score prediction model learning unit 5010 determines whether to perform score prediction learning to be described below as step S5010 based on a predetermined condition. As a specific example, if the score prediction model learning unit 5010 determines that a predetermined period of one or more epochs has elapsed, the score prediction model learning unit 5010 may determine to execute score prediction learning, and then the processing may proceed to step S5010. In another example, if the calculated loss has decreased by a predetermined value or more from the initial value or the previous value of the loss, the score prediction model learning unit 5010 may determine to execute score prediction learning, and then the processing may proceed to step S5010. In particular, if the determination of the latter case is applied, learning processing on a score prediction model that adaptively follows changes in the model in the learning process can be implemented. If the score prediction model learning unit 5010 determines not to execute score prediction learning, the processing of step S5010 is skipped.

The processing of step S5010 is substantially similar to the processing of step S4001 illustrated in FIG. 7A, and thus detailed descriptions thereof will be omitted. In this case, the degradation unit 5005, the image quality improvement unit 5006, the restoration error calculation unit 5009, and the score prediction model learning unit 5010 respectively correspond to the degradation unit 4001, the image quality improvement unit 4002, the restoration error calculation unit 4003, and the score prediction model learning unit 4005 illustrated in FIG. 6A. To execute the processing of step S5010, some of the image sequences with the predetermined frame length stored in the training data set 5011 are used as the image sequences.

The model (e.g., NR model) trained as described above is used for processing to be performed during run-time. The processing to be performed during run-time is substantially similar to that in the first exemplary embodiment, and thus detailed descriptions thereof are omitted.

As described above, the image processing system according to the present exemplary embodiment is configured to extract a learning case with a higher learning effect that is adaptable to the model (e.g., NR model) that is gradually updated in the learning process.

### Modified Example of Third Exemplary Embodiment

The third exemplary embodiment described above illustrates an example where filtering of image sequences is performed based on a score. On the other hand, in the technique according to the third exemplary embodiment, during filtering of image sequences, processing of extracting feature amounts and predicting scores is performed on a number of image sequences more than or equal to the mini-batch size. Accordingly, the calculation cost may increase depending on the number of a series of image sequences to be used as parameters for filtering of image sequences. To reduce the calculation cost, the score for each image sequence may be used as a weight during loss calculation, without performing filtering of image sequences. By applying such control processing, it can be expected to reduce the adverse effect of a learning case with a lower learning effect on learning processing and to enhance the effect of increasing the effect of a learning case with a higher learning effect on learning processing.

In the third exemplary embodiment described above, the feature amounts for each image sequence are calculated in the processing of step S5003 in the loop of a series of processing for learning processing illustrated in FIG. 7C. However, since the feature amounts are independent of the NR model and the score prediction model, they can be calculated in advance.

Accordingly, multiple-dimensional features for the series of image sequences stored in the training data set 5011 may be calculated and stored in association with the image sequences. By applying such control processing, the processing for extracting feature amounts to be processed in step S5003 illustrated in FIG. 7C can be omitted. Therefore, it can be expected to obtain the advantageous effect of reducing the calculation cost during model learning. According to this technique, prediction processing using the score prediction model is performed in the processing of step S5004 illustrated in FIG. 7C. It can be expected to obtain this advantageous effect even when a smaller prediction model with sufficiently low calculation cost is used. Consequently, the advantageous effect of suppressing an increase in the calculation cost can be expected by applying this control processing also in the configuration in which filtering is performed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-140407, filed Aug. 30, 2023, which is hereby incorporated by reference herein in its entirety.

What is claimed is:

1. A data processing apparatus comprising:
at least one processor; and
at least one memory storing instructions that, upon execution of the stored instructions, cause the at least one processor to:
calculate a restoration error associated with restoration of a restored image sequence based on the restored image sequence restored from a degraded image sequence obtained by degrading a reference image sequence and at least one of the reference image sequence or the degraded image sequence;
calculate a score according to a type of a feature amount based on the restoration error and a feature amount of a predetermined type extracted from the degraded image sequence; and
extract a reference image sequence to be used for creating a data set from a series of the reference image sequences based on the score.

2. The data processing apparatus according to claim 1,
wherein the instructions further cause the one or more processors to:
extract feature amounts of a plurality of types of images from the restored image sequence as a plurality of selection reference features; and
select an extraction method of extracting the feature amount to be applied to the calculation of the score and a calculation method of calculating the score based on the feature amount from among a plurality of types of candidates for the extraction method and a plurality of types of candidates for the calculation method based on the restoration error and the plurality of selection reference features, and
wherein the plurality of selection reference features includes a feature amount based on at least a spatiotemporal frequency characteristic of an image sequence.

3. The data processing apparatus according to claim 2, wherein the plurality of selection reference features includes a feature amount related to a motion of a subject as the feature amount based on the spatiotemporal frequency characteristic of the image sequence.

4. The data processing apparatus according to claim 3, wherein the feature amount related to the motion of the subject is an optical flow.

5. The data processing apparatus according to claim 2, wherein the instructions further cause the one or more processors to select the feature amount selection method and the score calculation method with a higher correlation between the restoration error and the score calculated from each of the plurality of selection reference features.

6. The data processing apparatus according to claim 1, wherein the instructions further cause the one or more processors to apply the restoration error output from a prediction model as the score by inputting the feature amount of the predetermined type extracted from the degraded image sequence to the prediction model trained based on machine learning to predict the restoration error using a feature amount extracted from the reference image sequence as an input.

7. The data processing apparatus according to claim 6, wherein the instructions further cause the one or more processors to apply a multiple-dimensional restoration error output from the prediction model as a multiple-dimensional score using multiple-dimensional feature amounts of a plurality of feature amounts including a feature amount based on at least a spatiotemporal frequency characteristic of an image sequence as an input to the prediction model.

8. The data processing apparatus according to claim 7, wherein the prediction model is a regression model using the multiple-dimensional feature amounts as an explanatory variable and using the restoration error as an objective variable.

9. The data processing apparatus according to claim 7, wherein the prediction model is a neural network trained using the multiple-dimensional feature amounts as an input and using the restoration error as a ground truth.

10. The data processing apparatus according to claim 1, wherein the restoration error is one of Peak Signal to Noise Ratio (PSNR) or Structural SIMilarity (SSIM) calculated from the restored image sequence and the degraded image sequence.

11. The data processing apparatus according to claim 1, wherein the restoration error is one of Peak Signal to Noise Ratio (PSNR) or Structural SIMilarity (SSIM) between frames calculated from the restored image sequence and the degraded image sequence.

12. The data processing apparatus according to claim 1, wherein the instructions further cause the one or more processors to extract a reference image sequence to be used for creating a data set from the series of reference image sequences based on a probability indicated by a value obtained after normalizing the score to represent as a value indicating a relative ratio to a maximum value.

13. An image processing apparatus comprising:
at least one processor; and
at least one memory storing instructions that, upon execution of the stored instructions, cause the at least one processor to:
perform learning processing based on machine learning by performing processing, on an image sequence received as an input, of restoring a degradation occurring in the image sequence to generate and output a restored image sequence,
wherein a data set to be used for the learning processing is generated based on a reference image sequence extracted from a series of reference image sequences based on a score according to a type of a feature amount, the score being calculated based on a restoration error associated with restoration of the restored image sequence and a feature amount of a predetermined type extracted from the degraded image sequence, the restoration error being calculated based on the restored image sequence restored from a degraded image sequence obtained by degrading the reference image sequence and at least one of the reference image sequence or the degraded image sequence.

14. The image processing apparatus according to claim 13, wherein the learning processing is performed based on a loss between the reference image sequence included in the data set preliminarily generated and the restored image sequence restored from the degraded image sequence generated by degrading the reference image sequence.

15. The image processing apparatus according to claim 14,
wherein the degraded image sequence is generated by degrading at least a predetermined number of reference image sequences extracted from the series of reference image sequences based on the score predicted from multiple-dimensional feature amounts of a plurality of feature amounts including a feature amount based on a spatiotemporal frequency characteristic of at least an image sequence extracted from the reference image sequence, and
wherein the learning processing is performed based on a loss between at least some of the extracted reference image sequences and the restored image sequence restored from the degraded image sequence generated from the reference image sequence.

16. The image processing apparatus according to claim 15,
wherein the restoration error output from a prediction model is applied as the score by inputting the feature amount of the predetermined type extracted from the degraded image sequence to the prediction model trained based on machine learning to predict the restoration error associated with restoration of the restored image sequence based on the restored image sequence and at least one of the reference image sequence and the degraded image sequence using a feature amount extracted from the reference image sequence as an input, and
wherein the learning processing is performed in a case where the prediction model satisfies a predetermined condition in a learning process.

17. The image processing apparatus according to claim 16, wherein the learning processing is performed in a case where a change in the loss in the prediction model is greater than or equal to a threshold in the learning process.

18. The image processing apparatus according to claim 15, wherein the reference image sequence included in the data set is associated with the multiple-dimensional feature amounts extracted from the reference image sequence.

19. A method for a data processing apparatus, the method comprising:
calculating a restoration error associated with restoration of a restored image sequence based on the restored image sequence restored from a degraded image sequence obtained by degrading a reference image sequence and at least one of the reference image sequence or the degraded image sequence;
calculating a score according to a type of a feature amount based on the calculated restoration error and a feature amount of a predetermined type extracted from the degraded image sequence; and
extracting a reference image sequence to be used for creating a data set from a series of the reference image sequences based on the calculated score.

20. A non-transitory computer-readable storage medium storing a program for causing a computer to execute a method for a data processing apparatus, the method comprising:
calculating a restoration error associated with restoration of a restored image sequence based on the restored image sequence restored from a degraded image sequence obtained by degrading a reference image sequence and at least one of the reference image sequence or the degraded image sequence;
calculating a score according to a type of a feature amount based on the calculated restoration error and a feature amount of a predetermined type extracted from the degraded image sequence; and
extracting a reference image sequence to be used for creating a data set from a series of the reference image sequences based on the calculated score.
